(19) United States
(12) Patent Application Publication
(10) Pub. No.: US 2005/0087045 A1
(43) Pub. Date: Apr. 28, 2005

(54) Emergency tool and system

(76) Inventors: Piotr Gryciuk, Santa Clara, CA (US); Kevin Patrick Fitzgerald, Santa Clara, CA (US)

Correspondence Address: EDWARD S. SHERMAN, ESQ., 3554 ROUND BARN BLVD., SUITE 303, SANTA ROSA, CA, 95403, US

(21) Appl. No.: 10/695,321

(22) Filed: Oct. 27, 2003

(51) Int. Cl. B25B 15/00

(52) U.S. Cl. 81/436

(57) ABSTRACT

A single tool T-shaped tool terminates at the bottom of its vertical portion with a first rectangular slot or socket for holding a nested and detachable socket for turning a rectangular valve lever arm engaged therein. Each of the first and second rectangular slot and socket mate with a corresponding gas and water supply valve levers wherein rotating the horizontal cross-arm of the T section opens or closes the corresponding supply line. The first and second rectangular components that define the valve lever arm engaging sockets are each marked with a different surface intended to correspond with surface marking on the supply line or valve lever to facilitate easy and rapid identification of the valve in emergencies.

### CROSS REFERENCE TO RELATED APPLICATIONS

None

### BACKGROUND OF INVENTION

The present invention relates to shutoff tools for utilities such as gas and water, and particularly to shutoff tools, which are capable of shutting off more than one utility.

Catastrophic emergencies such as floods, landslides, tornados, hurricanes, windstorms, earthquakes, etc. can suddenly strike a residence, a business, a neighborhood or an entire metropolitan area without warning. The primary significant risk to people and property is well understood, it being recognized that individual homeowners should take all steps possible to prepare for such emergencies. However, a secondary risk of fire and flooded exists from severed utility lines in such catastrophic disasters. Individual homeowners are advised to be prepared to shut off pipelines carrying natural gas into their residences. This step is important to prevent explosions from weakened gas pipes, joints and valves. For similar reasons, it is also recommended that homeowners be prepared to shut off water lines flowing into their residences to minimize the dangers of sudden water line failures and resultant flooding.

While this secondary risk can be mitigated by prompt disconnection of utility lines, this is frequently not the case for several reasons. Some catastrophic disasters, such as earthquakes and tornadoes, can happen anytime with little if any warning. As utility disconnect valves are not often touched and have a tendency to stick or actually corrode, requiring extra physical effort to disconnect by turning the valve. Persons with limited manual strength such as children, the handicapped and the elderly, require a wrench, key or special tool that provides a large lever to accomplish the task.

While these problems are recognized in part by others, as disclosed in several US patents and applications, notably, the corresponding solutions fall short of simultaneously addressing these difficulties. As speed is also important, several types of multiple purpose or “dual” keys capable of shutting off both gas and water main valves have been proposed. Generally, a first tool is needed to shut off gas lines. (Gas line shutoff valves generally are located above ground, usually along the side of the house near the gas flow meter. To close the valve, most gas shutoff valves require turning a valve stem one-quarter turn. The valve steam usually has a wrench attachment, which is about an inch long and about 7/16 inches wide.) A second tool is needed to shut off water lines. (The shutoff valve for most residential water valves is generally located in a concrete box, which is disposed below ground. Turning a valve stem a quarter turn generally turns off the valve. The valve stem for water shutoff valves is usually quite different from the valve stem for most gas shutoff valves, having a square cross-section.

Several inventors propose that a dual key should be retractable or foldable to take up minimum space when stored. That is about 1/2 inch on a side.) While multipurpose folding tools are indeed favored by emergency response professionals, the benefits can be disadvantage for an occasional user or the homeowner. The compact size of many multi-purpose functions makes it easy to misplace the tool, or divert it to other locations and uses making it hard to locate during an emergency. Further, to the extent the method of use requires a different manner of gripping the tool to exert force on a valve this can be problematic in panic situations. This is particularly true of multi-purpose collapsible tools, intended to be compact, as they require the user to have the presence of mind to set up or assemble the tool, and then to identify the correct portion of the tool to use on the utility valve.

Indeed, even with a tool designed for use by the average homeowner is useless if it is too complex or requires too much strength, as the buyer may not be home at the time of the emergency. Additionally, the utility service disconnect points may be difficult to find or access. Qualified and knowledgeable personnel are not likely in community disasters to be available to respond rapidly.

Accordingly, a rapid response may be required by persons either unfamiliar with the utility layout, or lacking strength to use conventional tools. Further, as such a disaster may occur at night even a qualified individual may have difficulty finding a tool designed for a water main and a gas main, or distinguishing between the proper tools.

Accordingly, there exists a need for a utility shut off method and associated tool that overcomes the aforementioned difficulties of the art.

It is therefore a first object of the present invention to provide a multi-purpose emergency shut off tool that is easy to use, yet also aids in finding the correct utility valves and using the correct portion of the tool for each valve.

Ideally, such a tool will be large enough so that it is easy to find and use by persons of virtually all mechanical expertise and physical ability, as well as aid in finding and accessing water and gas utility disconnect lines in any variety of locations.

### SUMMARY OF INVENTION

In a preferred embodiment of the present invention, the first object is achieved by providing a T-shaped tool having a pair of nested recessed portion at the bottom of the T-section, such that the first section is adopted for a gas line and the second section for a water main valve.

A second aspect of the invention is characterized in that the first section is removable from the first section such that the tool is used in the same manner for shutting the gas and water lines, as removal of first or inner nested work piece engaging component, after use, then presents the alternative work piece engaging component or closing a water main valve.

Accordingly, the vertical portion of the T-shaped multi-purpose tool provides a long vertical reach for the water main valve, but is also suitable for use on gas line valves. The width of the horizontal portion of the T-shaped tool increases the leverage for persons of limited manual strength to be able to turn both the gas and water valves.

A second aspect of the invention is a method and system for identifying and closing utility valves in an emergency, in the most preferred embodiment of this aspect the nested segments are coded with surface indicia for matching with the correct utility valve, the utility lines and valves having a corresponding color marking or other indicia.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A and 1B are elevations of a first embodiment of the tool configured for gas line and water line shut off respectively.

FIG. 2A, B and C are orthogonal cross sections through the work piece engaging component of the tool showing the nested configuration the removable socket inside the fixed socket at the tip of the tool as assembled in FIG. 1A.

FIG. 3 illustrates the methods of using the tool configurations of FIGS. 1A and 1B.

FIG. 4 illustrates in a perspective view the use of an alternative tool according to the method of the instant invention.

### DETAILED DESCRIPTION

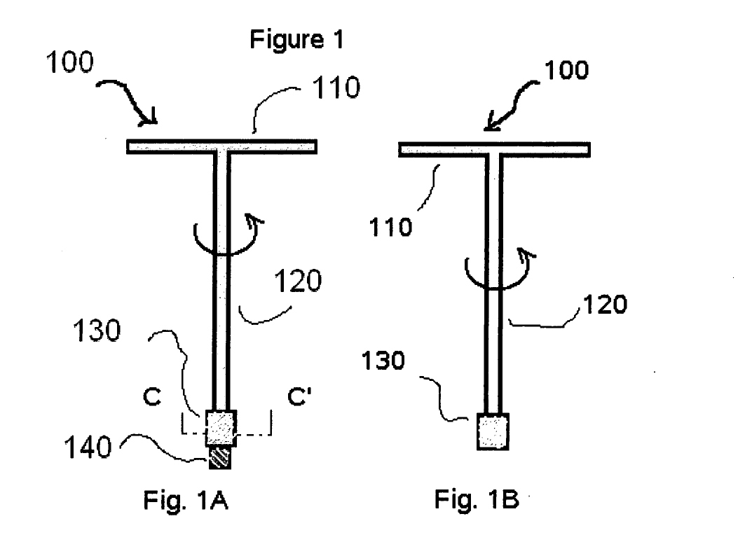

In accordance with a first aspect of the present invention, a tool 100 is adopted to turn flow control valve levers, the work piece, in emergencies is illustrated in FIG. 1. The tool 100 is generally operated from a hand engagable cross-arm 110 bisected by an extension arm 120 extending from the center of the cross arm 110. The distal end of the extension arm 120 terminates in a work piece engaging socket. In this embodiment a first rectangular section 130 is disposed at the distal end extension arm 120, the first rectangular section 130 having an open end 131 that form a lever or work piece engaging socket 130. The socket opening 131 of rectangular section 130 is one of two work engaging portion of tool 100. Accordingly, socket opening 131 is proportioned to receive the corresponding valve lever of emergency disconnect utility line. As the cross-arm 110 represents the hand engagable portion of the tool, the longitudinal axis of extension arm 120 is orthogonal with respect to the long axis of the rectangular section 130, being disposed in the plane parallel to that of the plane defining socket-opening 131. According, by grasping opposing sides of cross-am 110 and rotating the cross arm 110 about the common axis of the extension arm 120, the operator has considerable leverage to rotate the work piece engaging socket 131, thus rotating the confined valve lever to close the utility line. The extension arm 120 allows the user to reach into a sub-surface utility box to reach the water main and associated valve, as well as to gas disconnect lines in tight locations.

As shown in FIG. 1A, a second work-engaging portion 141 of tool 100 is a found at the open end of second rectangular section 140. Second rectangular section 140 is secured in disengagable attached to the distal end of extension arm 120. The second rectangular section 140 is preferably secured to extension arm 120 by nested engagement in receiving socket 131, such that the open end of the rectangle 141 present a second socket opening. This second socket opening 141 is adopted to accept a smaller diameter valve level;
such as typically used on a gas supply line shut off valve. It should be appreciated that by nesting the rectangular section 140, that forms the second work piece engaging portion 141, inside the first rectangular both work piece engaging socket 131 and 141 are co-axial such that the user operates the tool in the same manner to disconnect the gas and water lines.

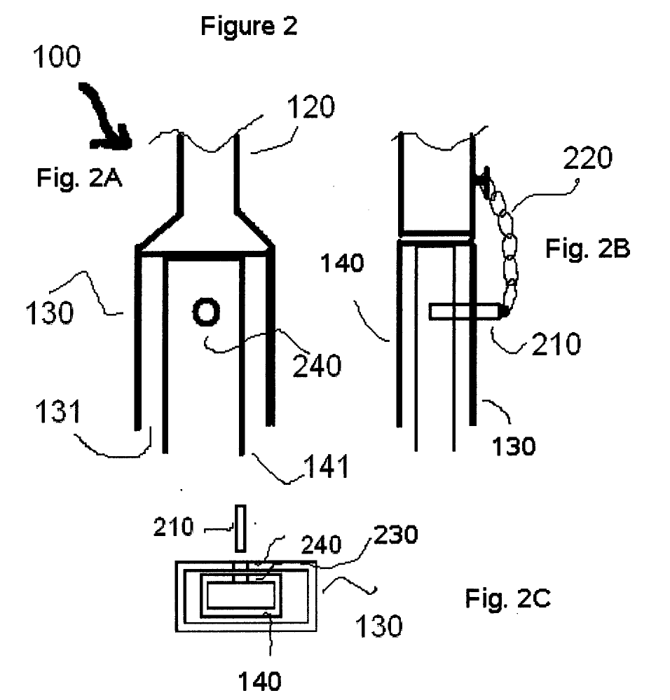

FIG. 2 illustrates further details of the nested arrangement that provides a combination of detachably engagable rectangular sockets at the distal end of extension arm 120. The orthogonal sections of the first and second rectangular sections in FIG. 2A, B and C, illustrate the nominal assembly conditions in which the removable rectangular section 140 is longer than the depth of the socket 131 as defined by the length of the first rectangular section 130. Accordingly, the socket portion 141 associated with the removable rectangular section 140 extend beyond the first or fixed socket end 131.

FIG. 2 also illustrates a preferred embodiment wherein the first rectangular socket is formed from a rectangular section 130 attached to the end of the extension 121. Thus, the inner dimensions of the second socket are adopted to grasp the first lever to be turned in an emergency, normally the gas line, whereas subsequently removing the rectangular section 140 that define socket 141 instantly configures the tool to receive a second and larger valve lever, generally associated with a water supply line in socket 131.

The currently preferred embodiment deploys nested rectangular sockets to function as work engaging portions, with the enclosed sidewalls of defining a spaced apart opening adapted to receive a valve lever. However, the socket need not be an enclosed rectangle to engage and rotate the valve lever arm, as pair of rigid parallel walls is sufficient. To the extent that a local utility utilizes a special lever configuration or requires a unique matching key, such as in a torx screw driver and the like, the nested sections illustrated in FIG. 2 are readily modified without departing from the intended scope of the invention. The first and second work piece engaging portions of the tool need not be nested, so long as each is sufficiently close to the axis of extension arm 120 that a user can rotate the cross-arm in the same manner for closing both the gas line and water line in an emergency. However, in other aspects, it is also preferable that the work engaging portions are otherwise arranged to be used in the alternative, so the user does not waste time or become frustrated trying to rotate a valve with the wrong size socket. As will be further described in more detail, it is also preferable that the alternative work piece engaging portions are sufficiently distal that they can be marked to correspond with the appropriate utility line, access port, valve or valve lever. Accordingly, the alternative work piece engaging portion may be otherwise arranged to that the are quickly reconfigured to match the other utility line marking, usually the water line, after the gas line is disconnected.

Although the nested rectangular sections that define work piece engaging sockets in FIG. 1 may be held together by friction, a preferred embodiment deploys a latching mechanism for retaining the removable rectangular section in the first rectangular section 130. As further illustrated in FIG. 2, a preferred embodiment of such a latch is pin 210 that is passed through corresponding apertures 230 and 240 formed in the respective sidewalls of the first 130 and second 140 rectangular sections. A cotter pin (or similar device having two generally parallel linear segments that can be reoriented with respect to each other by an elastic connecting member) is preferably deployed, as it will normally hold the nested segments in place until the user applies sufficient force to remove it. Pin 210 is optionally disposed on a chain 220, or other flexible tether member, that attaches to extension arm 120 above the rectangular section 120. Alternative embodiments for such latching mechanisms include spring-supported ball or pin disposed within rectangular section 140 distal from socket end 141, the ball or pin extending at least in part through apertures 230 and 240. In this configuration, the application of lateral force in the removal of rectangular section 140 will depress the ball and attached spring member permitting it to disengage from rectangular section 130.

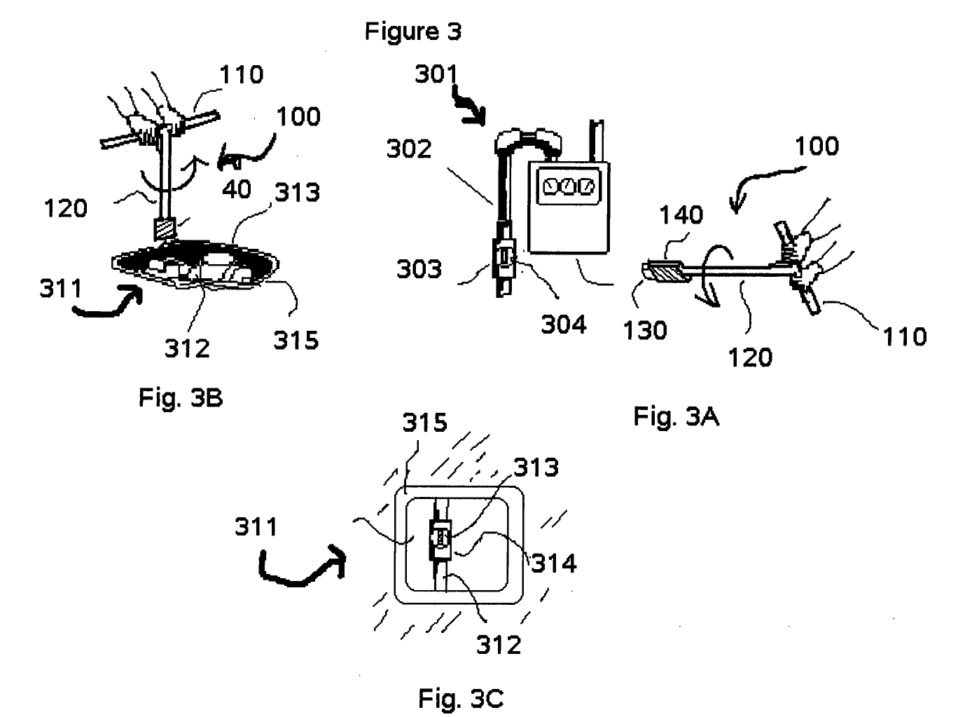

In yet another aspect of the invention, as illustrated in FIG. 3 there is provided a method of emergency disconnection of utility lines with a single tool having multiple lever-engaging portions. In the first step of the method some component outside or within the utility disconnect service location and/or control (301 for the gas line and 311 for the water line) is marked to correspond with the distinct indicia or otherwise identifying characteristics of a first work piece engaging portion of the tool, for example the same color as the rectangular section 130 of tool 100 in FIG. 1. That is at least one of the gas line regions, pipes 302; valve housing 303 or valve lever 304 in FIG. 3A is marked in color or another visual indicator. Whereas the other utility disconnect service location is marked to correspond to the indicia of the second or alternative work piece-engaging portion of the tool, preferably a contrasting color. For example, in FIG. 3B at least one of the water main access portal 311, pipes 312, valve housing 313, bezel 315 and valve lever 314 is marked in color or another visual indicator.

It should be appreciated that tool 100 of FIGS. 1 and 2 is a preferred device for implementing this method, as each rectangular section that forms a work piece engaging socket is readily painted, dyed or anodized, integrally formed and the like to have a different color, and that the appropriate color is always found at the single work piece engaging portion of tool 100, i.e. the distal end of extension arm 120, being clearly visible is each configuration.

Thus, according to further steps in the method of using the tool of FIGS. 1 and 2 at the time of the emergency, the user first identifies the location 301 of the gas line 302, or disconnect valve lever 304 itself, by the comparing the corresponding markings on the external surface of the pre-configured work piece engaging socket of the tool at the very end of extension arm 120, that is nested rectangle 130. Upon locating the disconnect valve lever arm 304 the user the orients tool 100 such that extended socket opening 141 engages the lever arm 304. The user then rotates the cross-arm 110 to turn the lever arm a quarter turn to disconnect the gas supply. As the color indicated on the fixed rectangular section 140 will be visible at all times, the user is thus reminded to then proceed to disconnect the water supply 311, as shown in FIG. 3B, by first locating and opening an access port on the ground for the water line, shown in plan view in FIG. 3C. The nested or second rectangular section 130 can then be removed either before or after identifying the lever arm 313 of the water supply valve 313, so long as the user removes the nested rectangular section 140 from the larger rectangular section 130 before attempting to engage the water line valve lever arm. After the socket end 131 of the larger or fixed rectangular section engages the lever arm, the user then closes the valve 313 in the same manner as closing the gas supply line valve 303; by rotating the cross-arm 110 about extension arm 120 to turn lever arm 313.

It should be appreciated that as tool 100 2 is grasped and rotated in the same manner to close both the gas and water supply valve, as shown in FIG. 2, the task of reconfiguration is limited to detaching the nested rectangular section 140, thus minimizing the mechanical skill, strength or alertness that would be required under emergency conditions.

Thus, in preferred embodiments of the tool illustrated in FIG. 2 the rectangular components 130 and 140 that comprise the work piece or valve engaging sockets have external markings that differ dramatically. Such markings are preferably distinctly different colors, and more preferably correspond to distinct marking or colors deployed at or on the water and gas valves so that the valve levels are readily found in emergencies and the correct portion of tool 100 is used. That is, the color of inner nested rectangular section 130 matches the gas line valve lever, while the color of the permanent or outer rectangular section 140 matches water valve line lever arm.

It should be appreciated that the cross sectional dimensions of extension arm 120 and cross arm 110 need not be square, but can be rectangular or circular. To the extent that extension arm 120 is formed of a flat bar, alternative embodiment consistent with the preferred marking scheme and method includes providing a rectangular slot formed in extension arm 120, which optionally replaces the nested rectangular section 130. Similarly, the cross arm can also have a flat bar shape and contain such a work piece engaging slot. It will be apparent to one of ordinary skill in the art that numerous of embodiments within the scope of the invention are possible, provided the tool itself is sufficiently rigid to move sticky or corroded valves without suffering any distortion or structural failure. Such alternatives include making the cross-arm and extension arm detachable or collapsible on each other, as well as fabricating the extension arm in several detachable sections to vary the reach and or torque leverage of the device. Accordingly, it will be further apparent that the work piece engaging sockets or slots, previously attributed to the rectangular sections, may also be deployed to mate or attach the multiple sections together. In such embodiments the end of each section, or the entire section, is optionally marked to be distinct according to other teachings of this application.

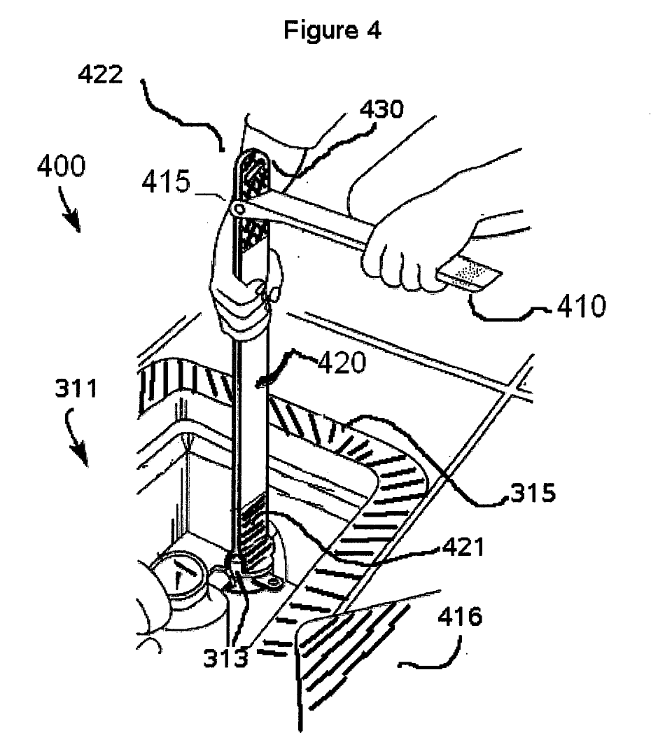

FIG. 4 illustrates one example of such an alternative embodiment of the invention, in which another multi-purpose tool 400 has surface markings corresponding to applicable utility line and access area. Tool 400 in this instance is a bar 420 having a first end 421 with an open slot for engaging the water valve lever 313 as shown in the Figure. Whereas a slot 430 in the bar near the opposite, or second, end 422 of bar 420 is dimensioned to engage a gas valve lever arm. According, the first 421 and second 422 ends are marked with differing shading to indicate their use, wherein the method of use preferably includes deploying identical or corresponding marking to the water or gas utility location of line. Thus, as shown in FIG. 4, the bezel 315 at the edge of water utility junction box 311 deploys the same exterior shading or marking patterns, in this case parallel lines, as the first end portion 421 of tool 400. Likewise, it the preferred method of use, the cover 416 of water utility junction box 311 deploys the same markings as bezel 315 and first end portion 421 of tool 400. It should be recognized from the drawing that the user rotates bar 420 using extension arm 410 as a lever. Accordingly, the user first rotates extension arm 410 about joint 415 so that it becomes orthogonal with bar 420 before attempting to turn valve lever arm 313. It should be understood that this Figure is not intended to limit or exclude the use of color as an indicator with this or other types of multi-purpose tools, but rather to emphasize that the surface indicia of the utility line and corresponding tool section need not be color, but may include numbers, letters, symbols, patterns and the like, as well as combinations thereof.

Thus also such marking indicators may be used directly on the surface of the water and gas line valve lever alone, they are also preferably placed around or on the surface of any of any of the valve, the pipe, the utility cabinet or utility porthole so to clearly identify the general location of the shut off valve from a distance. Accordingly, such marking indicators include labels, tape, discrete stickers, paints, marking pens, slit tubing, tags and the like. Surface indicia can also include a combination of external textures for tactile identification by the visually impaired, or for use in poor lighting conditions.

The use of color is a preferred indicating method, as paint can be applied to the surface of any of the valve, the pipe, the utility cabinet or utility porthole, whereas tapes and labels may have limited uses from durability or difficulty adhering to a small valve. However, in the most preferred embodiments the utility components are manufactured with integral color or durable surface indicia for greatest durability.

However, until such time as integral color or durable surface indicia becomes a conventional format for manufactured utility components of the type described herein, a further object of the invention is satisfied by providing a kit containing a multi-purpose tool, according to any of the above teachings, in combination with marking indicators enabling the method of use described with respect to FIG. 3 and FIG. 4. The marking indicators in the kit may includes any combinations of paint and attachable devices that correspond with the indicia of the discrete work engaging portions of the tools, be they in a nested arrangement on the tool (of which but one example is illustrated in FIG. 3), disposed at separate locations as shown in FIG. 4, and the like.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A tool for turning flow control valve levers, the tool comprising
a) a linear cross-arm member,
b) an extension arm connected at a first end to the center of the cross arm and extending therefrom to form a T-shaped tool,
c) a first rectangular section attached to the second end of the extension arm having a terminal opening to provide a first socket portion at the second end of the extension arm,
d) a second rectangular section nested inside the first socket portion having and having terminal opening to provide a second socket portion at the second end of the extension arm, said second rectangular section being detachable from said first rectangular section.

2. A tool according to claim 1 further comprising a latch for securing the second rectangular section to the tool.

3. A tool according to claim 1 further comprising a tether connecting the second rectangular section to the extension arm.

4. A tool according to claim 1 wherein the first and second rectangular section have visually distinct external markings.

5. A tool according to claim 1 wherein at least one of the first or second rectangular sections as a surface indicia selected from the group consisting of color, numbers, letters, symbols, shading and patterns.

6. A tool according to claim 5 wherein the surface indicia further comprises an external texture for tactile identification.

7. A tool according to claim 1 wherein at least one of the first or second rectangular sections is colored by a method selected from the group consisting of painting, applying tape, applying labels, integral color of the material used to fabricate the section and anodizing.

8. A tool for turning flow control valve levers, the tool comprising
a) a linear cross-arm member,
b) an extension arm connected at a first end to the center of the cross arm and extending therefrom to form a T-shaped tool,
c) a first work piece member for coupling to the second end of the extension arm and having a work piece engaging socket extending therefrom,
d) a second work piece member for coupling to the second end of the extension arm and having a work piece engaging socket extending therefrom,
e) wherein the first and second work piece engaging member are alternatively engage the extension arm such that either the first or second socket portion thereof is oriented substantially co-axial with the extension arm, the first work piece engaging member having a visually distinct external marking to distinguish it from the first work piece engaging member.

9. A tool according to claim 8 wherein at least one of the first or second rectangular sections as a surface indicia selected from the group consisting of color, numbers, letters, symbols, shading and patterns.

10. A tool according to claim 9 wherein the surface indicia further comprises an external texture for tactile identification.

11. A tool according to claim 8 wherein at least one of the first or second rectangular sections is colored by a method selected from the group consisting of painting, applying tape, applying labels, integral color of the material used to fabricate the section and anodizing.

12. A tool for turning flow control valve levers, the tool comprising
a) a linear cross-arm member,
b) an extension arm connected at a first end to the center of the cross arm and extending therefrom to form a T-shaped tool,
c) a first rectangular section attached to the second end of the extension arm forming a first rectangular slot at the end of the extension arm,
d) wherein at least one of the cross-arm and said extension arm have a flat bar shaped cross section with a rectangular slot formed therein,
e) wherein the external marking of the slot and rectangular section are visually distinct.

13. A tool according to claim 12 wherein at least one of the external markings is selected from the group consisting of color, numbers, letters, symbols, shading and patterns.

14. A tool according to claim 13 wherein the external markings further comprises an external texture for tactile identification.

15. A tool according to claim 12 wherein at least one of the external markings is colored by a method selected from the group consisting of painting, applying tape, applying labels, integral color of the material used to fabricate the section and anodizing.

16. A tool kit comprising;
a) A tool comprising;
i) a lever arm,
ii) a first rectangular slot coupled to the lever arm having a first slot width and marked by a first surface indicia,
iii) a second rectangular slot coupled to the lever arm having a second slot width and marked by a second surface indicia,
b) markers for visibly tagging utility supply valves to correspond with the slots of said tool, the marker comprising;
i) a first marking device corresponding to the first surface indicia for marking a valve handle having outer dimensions corresponding to the inner dimensions of the first slot,
ii) a second marking device corresponding to the second surface indicia for marking a valve handle having outer dimensions corresponding to the inner dimensions of the second slot.

17. A tool kit according to claim 16 wherein at least one of the first or second surface indicia is selected from the group consisting of color, numbers, letters, symbols, shading and patterns.

18. A tool kit according to claim 17 wherein the surface indicia further comprises an external texture for tactile identification.

19. A process for emergency control closure of gas and utility lines, the process comprising the steps of:
a) providing a gas supply line and valve having a first surface indicia,
b) providing a water supply line and valve having a second surface indicia,
c) providing a tool having,
i) a lever arm,
ii) a first slot for receiving the lever of the gas supply line,
iii) a second slot for receiving the lever of the water supply line,
iv) the first slot being marked with the first surface indicia and the second slot being marked with the second surface indicia,
d) inserting the slot having the first surface indicia over the gas supply lever,
e) rotating the lever arm of the tool to close the gas
f) inserting the slot having the second surface indicia over the water supply lever,
g) rotating the lever arm to close the water supply line.
